(19) United States
(12) Patent Application Publication
(10) Pub. No.: US 2015/0116221 A1
(43) Pub. Date: Apr. 30, 2015

(54) TOUCH MOUSE AND TOUCH CONTROL CIRCUIT BOARD THEREOF

(71) Applicant: Primax Electronics Ltd., Taipei (TW)

(72) Inventor: CHUNG-YUAN CHEN, Taipei (TW)

(73) Assignee: Primax Electronics Ltd., Taipei (TW)

(21) Appl. No.: 14/103,372

(22) Filed: Dec. 11, 2013

(30) Foreign Application Priority Data
Oct. 25, 2013 (TW) 102138735

(51) Int. Cl. G06F 3/0354

(52) U.S. Cl. CPC G06F 3/03543
USPC 345/163

(57) ABSTRACT

A touch mouse and a touch control circuit board of the touch mouse are provided. The touch mouse includes a mouse body, a light-emitting element, and the touch control circuit board. The mouse body includes a light-transmissible operation surface. The light-emitting element is disposed within the mouse body and emits a light beam. The touch control circuit board is disposed within the mouse body. The touch control circuit board includes plural conductive blocks and plural micro apertures. The plural micro apertures are formed in the plural conductive blocks. When the light-emitting element emits a light beam, the light beam from the light-emitting element passes through the plural micro apertures and then passes through the operation surface.

### FIELD OF THE INVENTION

The present invention relates to a mouse, and more particularly to a touch mouse with an illuminating function and a touch control circuit board of the touch mouse.

### BACKGROUND OF THE INVENTION

In the conventional computer system, a mouse is widely used to control a cursor position or a page scrolling action of a display screen of the computer system. Conventionally, a left button, a right button and a scroll wheel are essential components for assembling the mouse. Since the overall assembled structure of the conventional mouse is complicated and the conventional mouse fails to be operated in a touch control manner, the applications of the conventional mouse are limited. Due to the application limitations, the conventional mouse fails to provide a multi-touch function.

For solving the above drawbacks, the manufacturers of mouse devices make efforts in designing the mouse devices with a touch control function. FIG. 1 is a schematic exploded view illustrating a conventional mouse device with a touch control function. For example, the touch mouse 1 with the touch control function is disclosed in Taiwanese Patent No. TWM377639. As shown in FIG. 1, the mouse device 1 comprises a top cover 10, a capacitive sensor assembly 11, a circuit board 12, and a base 13.

The capacitive sensor assembly 11 comprises a first conductive layer 111 and a second conductive layer 112. The capacitive sensor assembly 11 is coupled to a bottom side of the top cover 10. Moreover, plural virtual key regions 101 are printed on a surface of the top cover 10. The first conductive layer 111 has plural sensing regions 111a, and the second conductive layer 112 has plural sensing regions 112a. The sensing regions 111a and 112a are aligned with the bottom sides of the virtual key regions 101. When one of the virtual key regions 101 is touched by the user's finger, a corresponding capacitive sensing signal is generated. According to the capacitive sensing signal, the function of the left button, the right button or the scroll button is correspondingly simulated in the touch control manner. Consequently, a multi-touch function is achieved.

The virtual key regions 101 are made of a light-transmissible material. In addition, the capacitive sensor assembly 11 is substantially a light-transmissible film. Consequently, a light beam from a light source mounted on the circuit board 12 may be guided by the capacitive sensor assembly 11. Under this circumstance, a backlight function is provided to the top cover 10.

As mentioned above, the virtual key regions 101 are aligned with the positions of the plural sensing regions 111a and the plural sensing regions 112a. Moreover, for achieving the backlight function of the touch mouse 1, the capacitive sensor assembly 11 should be made of the light-transmissible material. In other words, the plural sensing regions 111a and the plural sensing regions 112a should be made of the light-transmissible material. Generally, the light-transmissible material of the capacitive sensor assembly 11 includes for example indium tin oxide (ITO), nano silver or carbon nanotube. Regardless of which light-transmissible material is used, the material cost is very high. Under this circumstance, the touch mouse 1 is not cost-effective.

Therefore, there is a need of providing an improved touch mouse and a touch control circuit board of the touch mouse in order to eliminate the above drawbacks.

### SUMMARY OF THE INVENTION

An object of the present invention provides a cost-effective touch mouse with an illuminating function and a touch control circuit board of the touch mouse.

In accordance with an aspect of the present invention, there is provided a touch mouse. The touch mouse includes a mouse body, a light-emitting element, and a touch control circuit board. The mouse body includes a light-transmissible operation surface. The light-emitting element is disposed within the mouse body and emits a light beam. The touch control circuit board is disposed within the mouse body, and includes plural conductive blocks and plural micro apertures. The plural micro apertures are formed in at least one of the plural conductive blocks. The light beam from the light-emitting element passes through the plural micro apertures and then passes through the operation surface.

In accordance with another aspect of the present invention, there is provided a touch control circuit board. The touch control circuit board includes plural conductive blocks and plural micro apertures. The plural micro apertures are formed in at least one of the plural conductive blocks.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional mouse device with a touch control function;

FIG. 2 is a schematic perspective view illustrating the outer appearance of a touch mouse with a first type light-outputting region according to an embodiment of the present invention;

FIG. 3 is a schematic cross-sectional view illustrating the touch mouse of FIG. 2 and taken along the line A-A;

FIG. 4 is a schematic top view illustrating an exemplary touch control circuit board of the touch mouse of FIG. 2;

FIG. 5 is a schematic cross-sectional view illustrating the touch control circuit board of FIG. 4 and taken along the line B-B;

FIG. 6 is a schematic partial enlarged view illustrating the touch control circuit board of FIG. 4;

FIG. 7 is a schematic perspective view illustrating the outer appearance of a touch mouse with a second type light-outputting region according to an embodiment of the present invention;

FIG. 8 is a schematic top view illustrating an exemplary touch control circuit board of the touch mouse of FIG. 7;

FIG. 9 is a schematic perspective view illustrating the outer appearance of a touch mouse with a third type light-outputting region according to an embodiment of the present invention;

FIG. 10 is a schematic top view illustrating an exemplary touch control circuit board of the touch mouse of FIG. 9; and

FIG. 11 is a schematic partial enlarged view illustrating another exemplary touch control circuit board used in the touch mouse of the present invention.

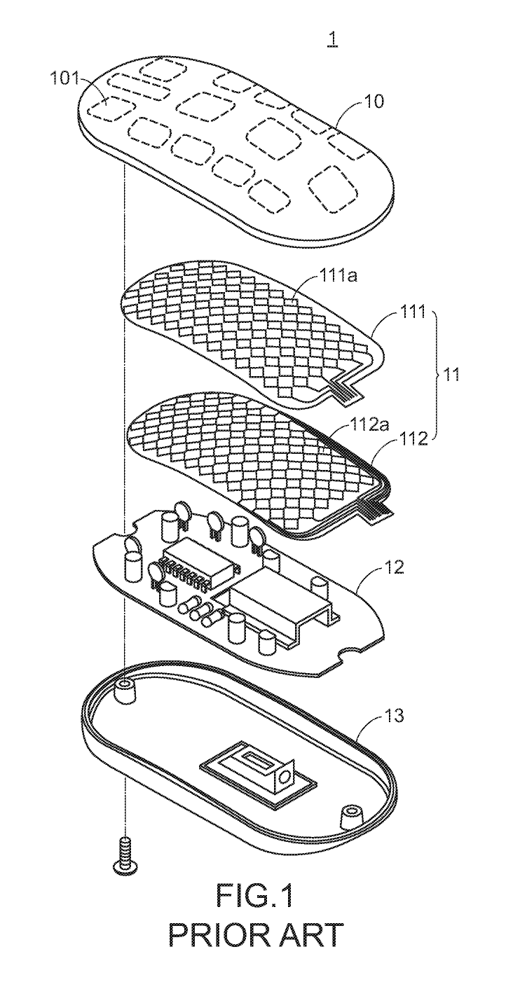

### DETAILED DESCRIPTION OF THE PREFERRED EMBODIMENT

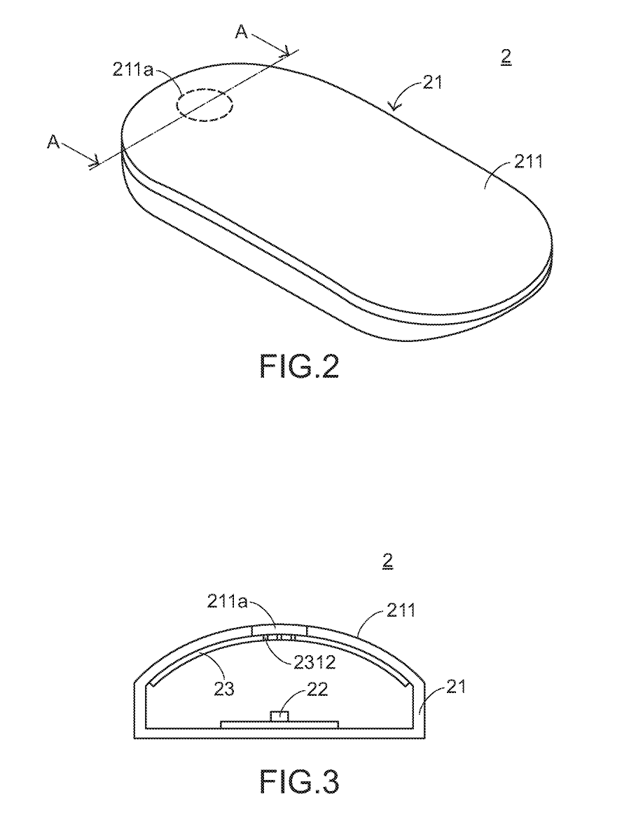

The present invention provides a touch mouse. Hereinafter, the components and the assembling sequence of a touch mouse according to an embodiment of the present invention will be illustrated with reference to FIGS. 2 and 3. FIG. 2 is a schematic perspective view illustrating the outer appearance of a touch mouse with a first type light-outputting region according to an embodiment of the present invention. FIG. 3 is a schematic cross-sectional view illustrating the touch mouse of FIG. 2 and taken along the line A-A.

The touch mouse 2 comprises a mouse body 21, at least one light-emitting element 22, and a touch control circuit board 23. The mouse body 21 comprises an operation surface 211. The operation surface 211 comprises a light-outputting region 211a. In an embodiment, the entire of the operation surface 211 is made of a light-transmissible material. Alternatively, in some other embodiments, only the light-outputting region 211a is made of the light-transmissible material.

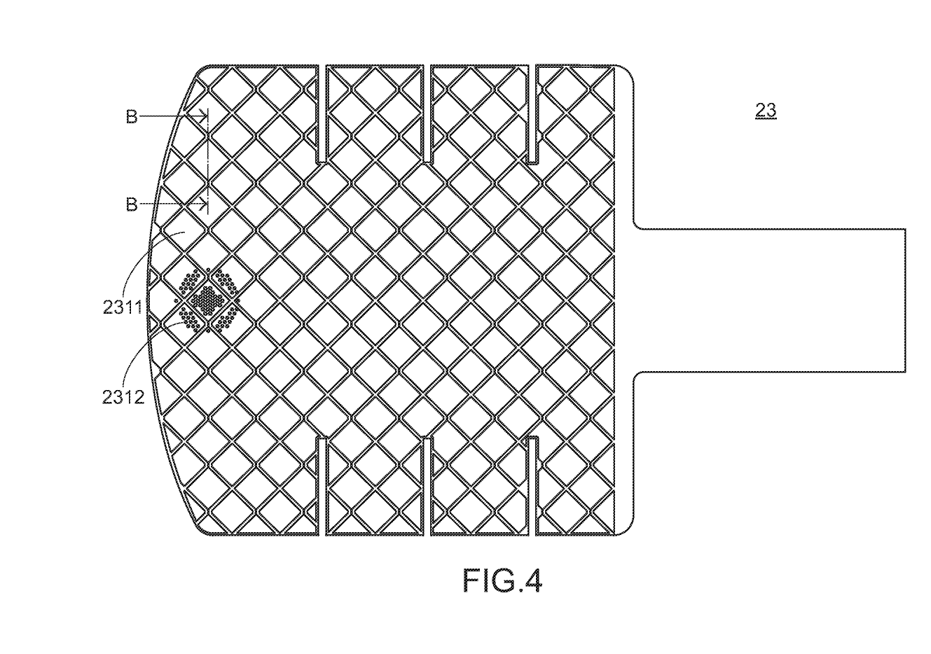

Then, the light-emitting element 22 and the touch control circuit board 23 are disposed within the mouse body 21. The touch control circuit board 23 is attached on an inner surface of the mouse body 21. Moreover, the touch control circuit board 23 comprises plural micro apertures 2312 (see FIGS. 4 and 6). The plural micro apertures 2312 of the touch control circuit board 23 are aligned with the position of the light-outputting region 211a.

Moreover, the light-emitting element 22 is disposed under the touch control circuit board 23. The number and position of the at least one light-emitting element 22 may be adjusted according to the coverage range of the light-outputting region 211a. A light beam from the light-emitting element 22 may pass through the plural micro apertures 2312 of the touch control circuit board 23 (see FIGS. 4 and 6) and then pass through the light-outputting region 211a of the operation surface 211. Consequently, the operation surface 211 is illuminated by the light beam. In this embodiment, the illuminated light-outputting region 211a may provide an indicating function or a touch control prompting function. For example, the illuminated light-outputting region 211a may indicate that the touch mouse 2 is in an on state or prompt that the illuminated position is simulated as a scroll wheel through touch control. The functions of the illuminated light-outputting region 211a are presented herein for purpose of illustration and description only.

Moreover, in this embodiment, the light-outputting region 211a contains a light diffusion agent. An example of the light diffusion agent includes but is not limited to titanium oxide. By using the light diffusion agent, the light beam passing through the plural micro apertures 2312 (see FIGS. 4 and 6) and the light-outputting region 211a can be optically scattered and diffused. Consequently, the light beam can be scattered uniformly, and the light-outputting region 211a of the operation surface 211 can be illuminated uniformly.

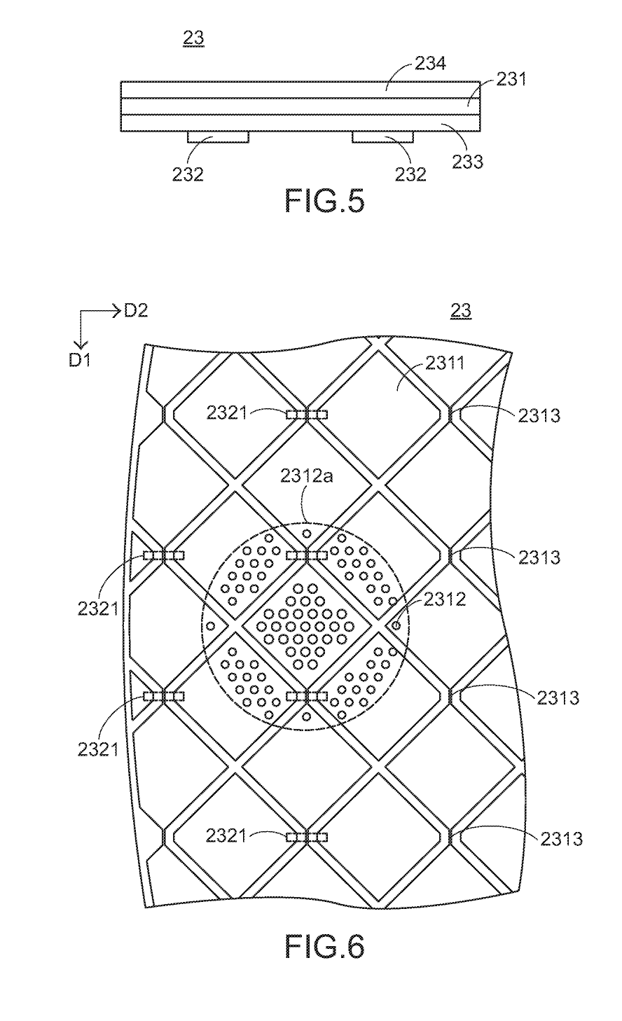

Hereinafter, the structure of the touch control circuit board 23 will be illustrated with reference to FIGS. 4, 5 and 6. FIG. 4 is a schematic top view illustrating an exemplary touch control circuit board of the touch mouse of FIG. 2. FIG. 5 is a schematic cross-sectional view illustrating the touch control circuit board of FIG. 4 and taken along the line B-B. FIG. 6 is a schematic partial enlarged view illustrating the touch control circuit board of FIG. 4.

In this embodiment, the touch control circuit board 23 is a flexible printed circuit (FPC) board. The touch control circuit board 23 comprises a first opaque conductive metal layer 231, a second opaque conductive metal layer 232, a substrate 233, and an adhesive layer 234. The substrate 233 is made of a flexible material. For example, the substrate 233 is made of PEN, PET, PES, flexible glass, PMMA, PC or PI. Alternatively, the substrate 233 is a multi-layered structure made of the above materials. Each of the first opaque conductive metal layer 231 and the second opaque conductive metal layer 232 may be made of copper alloy, aluminum alloy, gold, silver, aluminum, copper, or any other appropriate conductive metal or conductive alloy.

The first opaque conductive metal layer 231 is disposed on a top surface of the substrate 233. The first opaque conductive metal layer 231 comprises plural conductive blocks 2311 and the plural micro apertures 2312. The plural conductive blocks 2311 are arranged in a staggered configuration. In addition, the plural micro apertures 2312 are formed in some of the plural conductive blocks 2311. In this embodiment, the plural conductive blocks 2311 are rhombus-shaped. It is noted that the shapes of the conductive blocks 2311 are not restricted. Alternatively, in some other embodiments, the conductive blocks 2311 have hexagonal shapes, long strip shapes or triangular shapes, but are not limited thereto. Moreover, the shape and size of each micro aperture 2312 are not restricted. For example, each micro aperture 2312 is circular, square, triangular or polygonal, but is not limited thereto. The sizes of the plural micro apertures 2312 may be completely identical. Alternatively, in some other embodiments, the sizes of the plural micro apertures 2312 may be completely different.

A distribution range 2312a of the plural micro apertures 2312 are correlated with the coverage range of the light-outputting region 211a. According to the coverage range of the light-outputting region 211a, the plural micro apertures 2312 may be distributed on the plural conductive blocks 2311 or distributed on a single conductive block 2311. As shown in FIG. 2, the operation surface 211 of the touch mouse 2 has a single circular light-outputting region 211a. Consequently, as shown in FIGS. 4 and 6, the distribution range 2312a of the plural micro apertures 2312 is a single circular region corresponding to the light-outputting region 211a. Moreover, according to the size of the light-outputting region 211a, the plural micro apertures 2312 are distributed on the plural conductive blocks 2311.

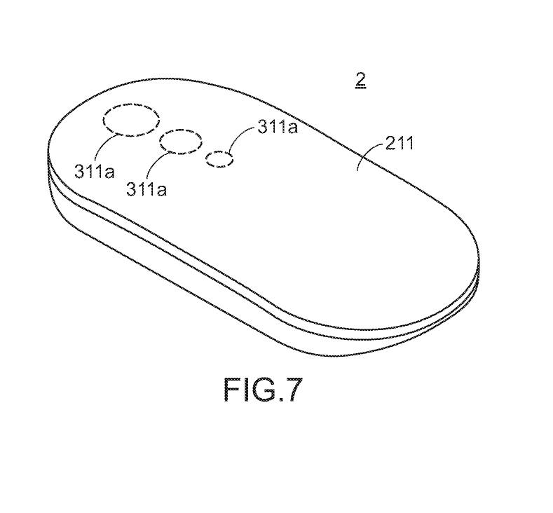

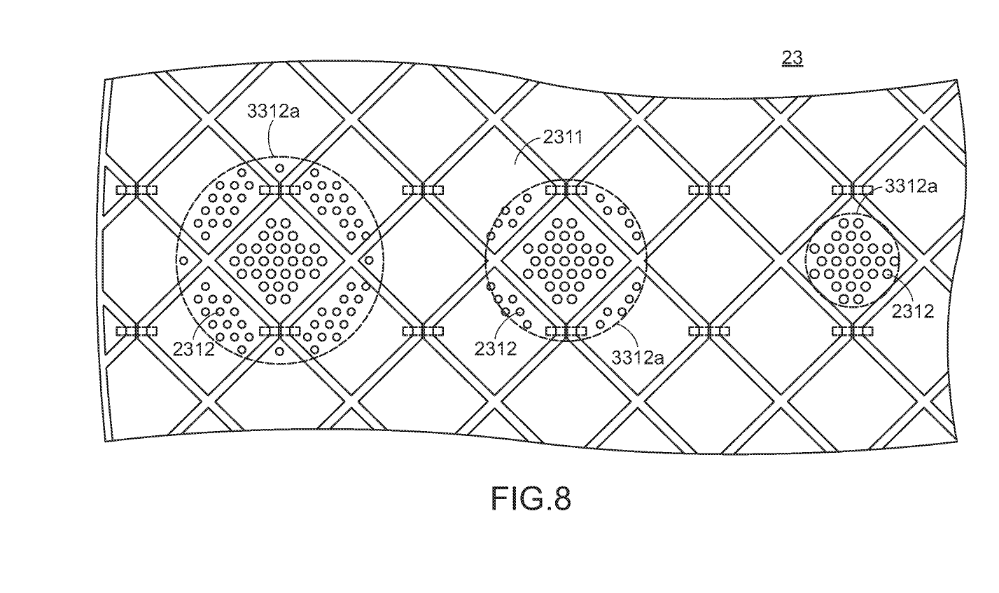

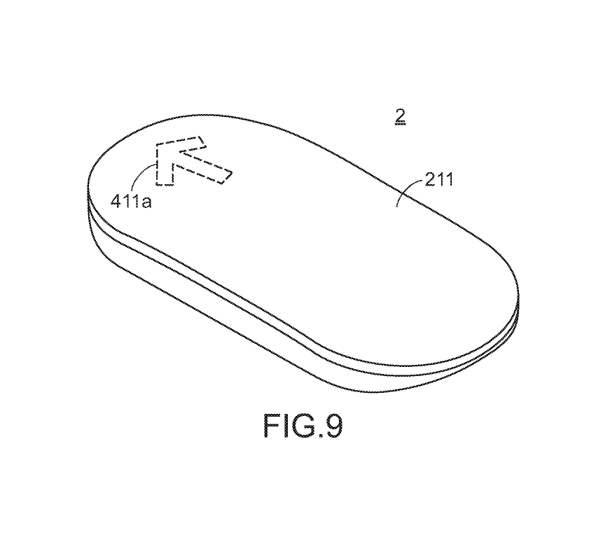

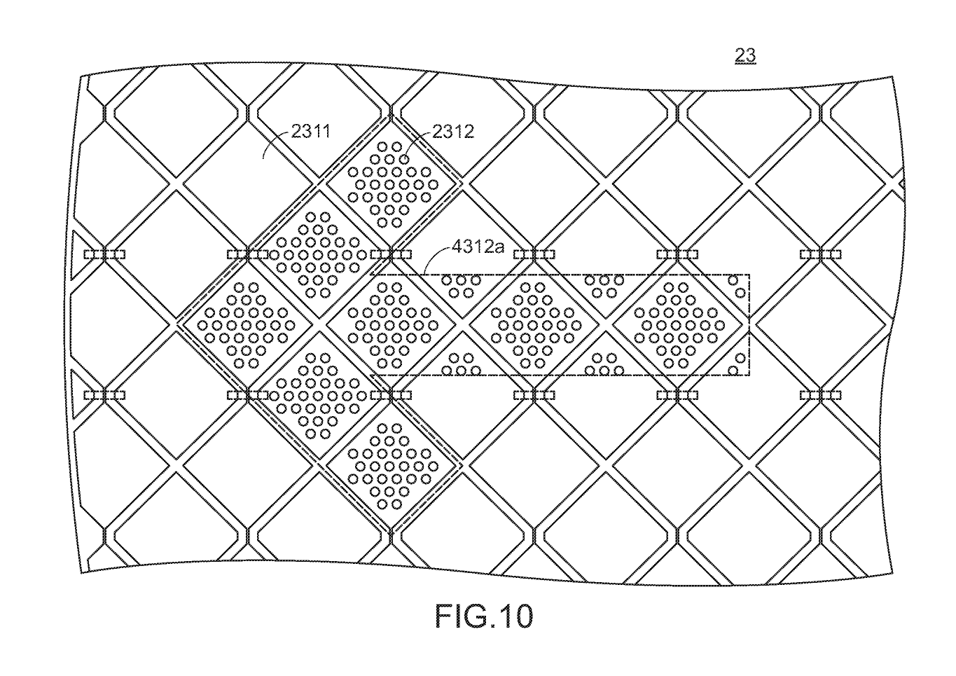

It is noted that the number and shape of the light-outputting region and the number and shape of the distribution range of the plural micro apertures may be varied according to the practical requirements. For example, the light-outputting region or the distribution range of the plural micro apertures may comprise plural circular regions, a single arbitrary-shaped region or plural arbitrary-shaped regions. The detailed description will be illustrated with reference to FIGS. 7˜10. FIG. 7 is a schematic perspective view illustrating the outer appearance of a touch mouse with a second type light-outputting region according to an embodiment of the present invention. FIG. 8 is a schematic top view illustrating an exemplary touch control circuit board of the touch mouse of FIG. 7. FIG. 9 is a schematic perspective view illustrating the outer appearance of a touch mouse with a third type light-outputting region according to an embodiment of the present invention. FIG. 10 is a schematic top view illustrating an exemplary touch control circuit board of the touch mouse of FIG. 9.

As shown in FIGS. 7 and 8, the operation surface 211 of the touch mouse 2 comprises plural circular light-outputting regions 311a with different sizes. Corresponding to the plural circular light-outputting regions 311a, the distribution ranges 3312a of the plural micro apertures 2312 of the touch control circuit board 23 are plural circular regions with different sizes. According to the coverage range of the light-outputting region 311a, the plural micro apertures 2312 within each distribution range 3312a may be distributed on the plural conductive blocks 2311 or distributed on a single conductive block 2311. As shown in FIGS. 9 and 10, the operation surface 211 of the touch mouse 2 comprises a light-outputting region 411a with a special shape. Corresponding to the light-outputting region 411a, the distribution range 4312a of the plural micro apertures 2312 of the touch control circuit board 23 is a special shaped region. In addition, the plural micro apertures 2312 are contiguously distributed on the plural conductive blocks 2311.

Please refer to FIGS. 4, 5 and 6. The first opaque conductive metal layer 231 further comprises plural bridging lines 2313. The portions of the plural conductive blocks 2311 that are located adjacent to each other along a first direction D1 are electrically connected with each other through the plural bridging lines 2313. The second opaque conductive metal layer 232 is disposed on a bottom surface of the substrate 233. The second opaque conductive metal layer 232 comprises plural conducting lines 2321. The portions of the plural conductive blocks 2311 that are located adjacent to each other along a second direction D2 are electrically connected with each other through the plural conducting lines 2321. There is an included angle between the first direction D1 and the second direction D2. For example, the included angle between the first direction D1 and the second direction D2 is 90 degrees.

The plural micro apertures 2312 may be produced by performing an etching process or using a laser engraving machine. In an embodiment, during the process of producing the touch control circuit board 23, the plural conductive blocks 2311 are firstly formed by etching undesired parts from the first opaque conductive metal layer 231, and then the plural micro apertures 2312 are formed by etching parts of conductive metals from the plural conductive blocks 2311. In another embodiment, after the touch control circuit board 23 is produced, the plural micro apertures 2312 are created by using the laser engraving machine to engrave the plural conductive blocks 2311.

In case that the plural micro apertures 2312 are produced by performing the etching process, the plural micro apertures 2312 do not run through the substrate 233. Under this circumstance, the substrate 233 should be made of the light-transmissible material. In case that the plural micro apertures 2312 are produced by using the laser engraving machine, the plural micro apertures 2312 may run through the substrate 233. Under this circumstance, the substrate 233 may be made of the light-transmissible material or an opaque material.

Afterwards, the adhesive layer 234 is attached on the first opaque conductive metal layer 231. The touch control circuit board 23 is attached on the inner surface of the mouse body 21 through the adhesive layer 234. In this embodiment, the adhesive layer 234 is made of the light-transmissible material.

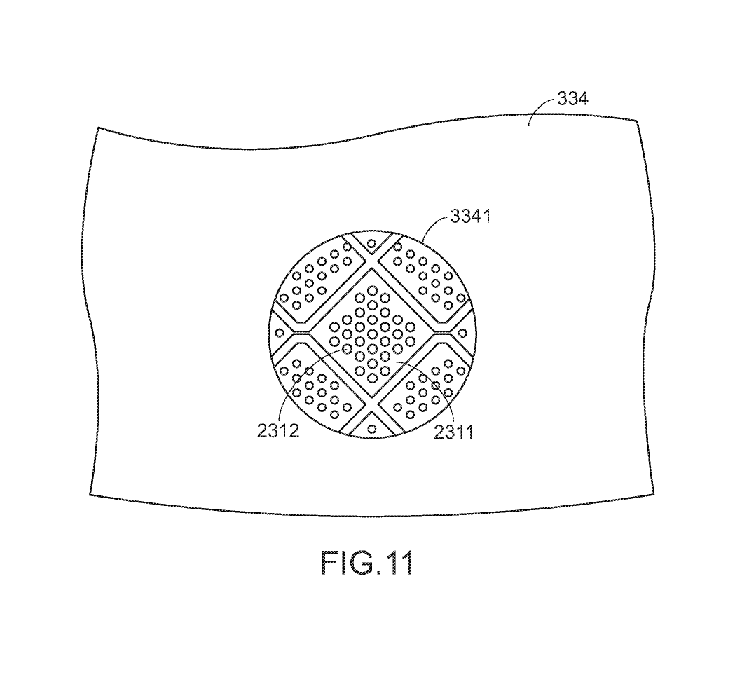

Hereinafter, another exemplary touch control circuit board 33 will be illustrated with reference to FIG. 11. FIG. 11 is a schematic partial enlarged view illustrating another exemplary touch control circuit board used in the touch mouse of the present invention. In comparison with the touch control circuit boar 23 of the above embodiment, an adhesive layer 334 of the touch control circuit board 33 is made of an opaque material.

As mentioned above, in case that the plural micro apertures 2312 are produced by performing the etching process, the plural micro apertures 2312 do not run through the substrate 233. Under this circumstance, the substrate 233 should be made of the light-transmissible material. For preventing the light beam from passing through the junctions between the substrate 233 and the plural conductive blocks 2311 (i.e. avoiding the light leakage), if the substrate 233 is made of the light-transmissible material, the adhesive layer 334 is made of the opaque material (see FIG. 11). Since the adhesive layer 334 is made of the opaque material, the adhesive layer 334 has at least one opening 3341 corresponding to the positions of the plural micro apertures 2312.

From the above descriptions, the plural micro apertures are formed in the plural conductive blocks of the touch control circuit board. Consequently, the conductive block does not need to be made of the expensive light-transmissible material such as indium tin oxide (ITO), nano silver or carbon nanotube. In other words, the present invention provides a cost-effective touch mouse with an illuminating function and the touch control circuit board of the touch mouse.

Moreover, by adjusting the distribution range of the plural micro apertures and the coverage range of the light-outputting region of the mouse body, the illuminated touch mouse can provide multiple indicating and prompting functions. Consequently, the operating flexibility of the touch mouse is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch mouse, comprising:
a mouse body comprising a light-transmissible operation surface;
a light-emitting element disposed within the mouse, and emitting a light beam; and
a touch control circuit board disposed within the mouse body, and comprising plural conductive blocks and plural micro apertures, wherein the plural micro apertures are formed in at least one of the plural conductive blocks, wherein the light beam from the light-emitting element passes through the plural micro apertures and then passes through the operation surface.

2. The touch mouse according to claim 1, wherein the plural conductive blocks are rhombus-shaped.

3. The touch mouse according to claim 1, wherein the touch control circuit board is a flexible printed circuit board.

4. The touch mouse according to claim 1, wherein the operation surface comprises a light-outputting region, and the light-outputting region is aligned with the plural micro apertures.

5. The touch mouse according to claim 4, wherein the light-outputting region contains a light diffusion agent, so that the light beam is scattered uniformly.

6. The touch mouse according to claim 1, wherein the touch control circuit board comprises:
a first opaque conductive metal layer comprising the plural conductive blocks;
a second opaque conductive metal layer comprising plural conducting lines, wherein the plural conductive blocks are connected with each other through the plural conducting lines; and
a substrate arranged between the first opaque conductive metal layer and the second opaque conductive metal layer, wherein the first opaque conductive metal layer and the second opaque conductive metal layer are separated from each other by the substrate.

7. The touch mouse according to claim 6, wherein the substrate is a light-transmissible substrate, and the plural micro apertures do not run through the substrate.

8. The touch mouse according to claim 6, wherein the plural micro apertures run through the substrate.

9. The touch mouse according to claim 6, wherein the touch control circuit board further comprises an adhesive layer, wherein the adhesive layer is attached on the first opaque conductive metal layer.

10. The touch mouse according to claim 9, wherein the adhesive layer is an opaque adhesive layer, wherein the adhesive layer has at least one opening corresponding to the plural micro apertures.

11. A touch control circuit board, comprising:
plural conductive blocks; and
plural micro apertures formed in at least one of the plural conductive blocks.

12. The touch control circuit board according to claim 11, wherein the plural conductive blocks are rhombus-shaped.

13. The touch control circuit board according to claim 11, wherein the touch control circuit board further comprises:
a first opaque conductive metal layer comprising the plural conductive blocks;
a second opaque conductive metal layer comprising plural conducting lines, wherein the plural conductive blocks are connected with each other through the plural conducting lines; and
a substrate arranged between the first opaque conductive metal layer and the second opaque conductive metal layer, wherein the first opaque conductive metal layer and the second opaque conductive metal layer are separated from each other by the substrate.

14. The touch control circuit board according to claim 11, wherein the substrate is a light-transmissible substrate, and the plural micro apertures do not run through the substrate.

15. The touch control circuit board according to claim 11, wherein the plural micro apertures run through the substrate.

16. The touch control circuit board according to claim 11, wherein the touch control circuit board further comprises an adhesive layer, wherein the adhesive layer is attached on the first opaque conductive metal layer.

17. The touch control circuit board according to claim 16, wherein the adhesive layer is an opaque adhesive layer, wherein the adhesive layer has at least one opening corresponding to the plural micro apertures.
